(19) United States
(12) Patent Application Publication
(10) Pub. No.: US 2009/0112644 A1
(43) Pub. Date: Apr. 30, 2009

(54) System and Method For Implementing a Service Oriented Architecture in an Enterprise

(76) Inventor: Pamela K. Isom, Highlands Ranch, CO (US)

Correspondence Address: DILLON & YUDELL LLP, 8911 N. CAPITAL OF TEXAS HWY.,, SUITE 2110, AUSTIN, TX, 78759, US

(21) Appl. No.: 11/923,291

(22) Filed: Oct. 24, 2007

(51) Int. Cl. G06Q 10/00; G06F 17/40; G06F 19/00

(52) U.S. Cl. 705/7

(57) ABSTRACT

A graphical representation of activities of an enterprise is created to aid in the implementation of a Service Oriented Architecture (SOA). The graphical representation has a vertical axis and a horizontal axis. Descriptive job titles of actors associated with the enterprise are documented along the horizontal axis. Functional domains are documented along the vertical axis. Existing business functions and existing key processes of the enterprise are then documented along the horizontal axis for each functional domain, and the functional domains are prioritized to determine an order in which the SOA is implemented.

### BACKGROUND OF THE INVENTION

The present disclosure relates to the field of computers, and specifically to software. Still more specifically, the present disclosure relates to implementing a Service Oriented Architecture (SOA) in an enterprise.

Service Oriented Architecture (SOA) describes the practice of utilizing autonomous or semi-autonomous services that communicate with one another by passing data and/or direction among themselves. The services are typically provided by a service provider to a service requester (i.e., service client) via a service broker (i.e., a service registry).

Implementing SOA into an enterprise that is using traditional resources (i.e., software running on local servers that are owned exclusively by the enterprise) poses many challenges. One challenge is understanding how SOA can integrate into an enterprise's business construct.

### BRIEF SUMMARY OF THE INVENTION

A graphical representation of activities of an enterprise is created to aid in the implementation of a Service Oriented Architecture (SOA). The graphical representation has a vertical axis and a horizontal axis. Descriptive job titles of actors associated with the enterprise are documented along the horizontal axis. Functional domains are documented along the vertical axis. Existing business functions and existing key processes of the enterprise are then documented along the horizontal axis for each functional domain, and the functional domains are prioritized to determine an order in which the SOA is implemented.

The above as well as additional objectives, features, and advantages of the present invention will become apparent in the following detailed written description.

### BRIEF DESCRIPTION OF THE SEVERAL VIEWS OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary computer in which the present invention may be implemented;

FIG. 2 is a high-level flow-chart of exemplary steps used by a Business Transformation Analysis and Modeling Method (BTAMM) to create a graphical representation, of an enterprise, that is used to identify and model key business functions of the enterprise; and

FIG. 3 is a graphical representation of an enterprise that has been created using BTAMM.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java® (Java® is a trademark or registered trademark of Sun Microsystems, Inc. in the United States and other countries), Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

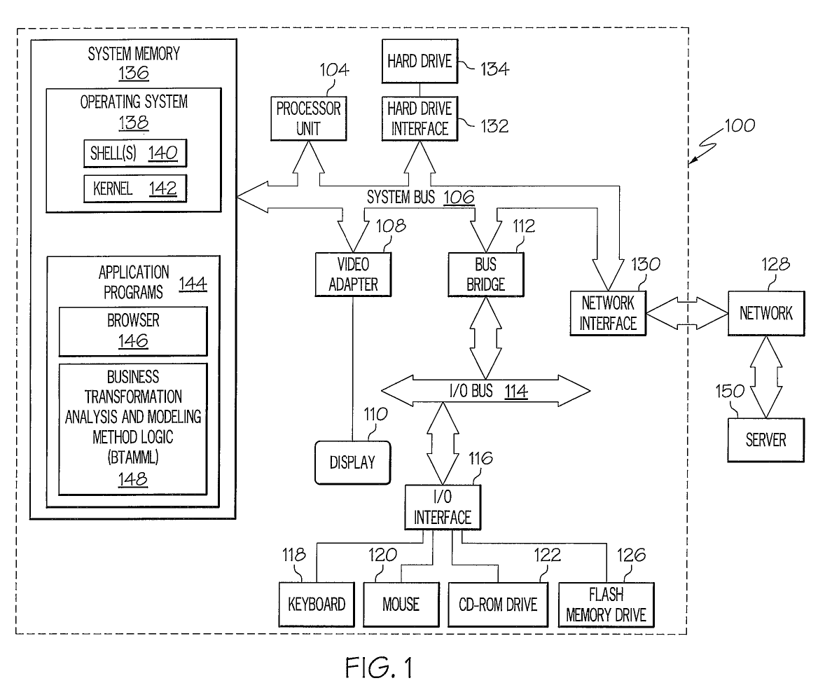

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk—Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®—UNIX is a registered trademark of The Open Group in the United States and other countries) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management. Note that UNIX® is merely an exemplary OS that can be utilized by the presently described computer 100, which may utilize any other appropriate OS, including, but not limited to, Windows® (Windows® is a registered trademark of Microsoft, Inc. in the United States and other countries), Linux® (Linux® is a registered trademark of Linus Torvalds in the United States and other countries), etc.

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include a Business Transformation Analysis and Modeling Method Logic (BTAMML) 148. BTAMML 148 is software that performs the functions described in the figures below. In one embodiment, computer 100 is able to download BTAMML 148 from service provider server 150, including in an “on demand” basis. In another embodiment, service provider server 150 performs all of the functions associated with the present invention (including execution of BTAMML 148), thus freeing computer 100 from using its own resources.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

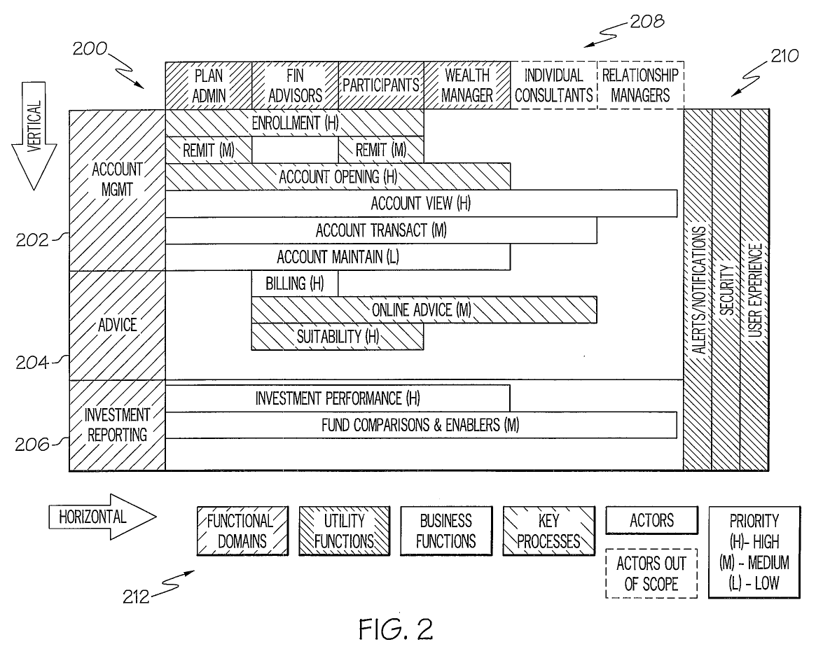

With reference now to FIG. 2, a graphical representation 200 of activities of an enterprise is presented. The graphical representation 200 has a vertical axis and a horizontal axis. Assume, for illustrative purposes only, that graphical representation 200 is for a financial services enterprise. Documented along the left vertical axis are functional domains of such a financial services enterprise, including “Account Management” 202, “Advice” 204, and “Investment Reporting” 206. Documented along the top of the horizontal axis are descriptive job titles of actors 208. Each functional domain is a consolidation of business functions and key processes that are performed in the enterprise by the actors 208. Each business function is a group of logically connected tasks that are performed together to accomplish a business objective of the enterprise. However, a business function cannot be decomposed, since it is a base process. An exemplary business function is a software application. Each key process is a mission critical activity of a particular functional domain. Each process, including key processes, is made up of multiple business functions, and thus is capable of being decomposed (broken down) for further evaluation and analysis. Thus, within each functional domain are documented both existing business functions and existing key processes of the enterprise.

For example, within the functional domain of “Account Management” 202, the enterprise (or a consultant to the enterprise) has identified three key processes: “Enrollment,” “Remit,” and “Account Opening.” “Enrollment” is the process of enrolling new customers in the enterprise's financial services product; “Remit” is a process that allows customers to move funds to and from their accounts; and “Account Opening” is a process that walks new customers through the process of setting up a new account. Note that the key process of “Enrollment” is part of the activities of three actors: “Plan Administrators” and “Financial Advisers” (enterprise employees) and the “Participant” (customer). Since all three actors are involved in the same key process, this key process should be reusable by any of the three actors, and thus is a good candidate for an SOA.

Note also that “Enrollment” has a high priority, “Remit” has a medium priority, and “Account Opening” has a high priority. These priority settings have been set by the enterprise and/or the enterprise's consultant. In one embodiment, these priority settings, as well as other priorities discussed below, are based on how much exposure a customer has to a process. In another embodiment, the priorities are based on how new a customer is. Thus, a new customer needs to have access to the “Enrollment” and “Account Opening” processes before he will need access to the “Remit” process. As described further below, the priority of a process may be used to determine the order in which processes are converted from existing local processes and functions to Service Oriented Architecture (SOA) processes and functions.

A key process may have multiple activities, including multiple business functions, which are described in greater detail below in an exemplary manner.

The functional domain of “Account Management” 202 also has business functions “Account View” (to allow a customer to view her account), “Account Transact” (to allow a customer to borrow from her fund, buy new products, etc.), “Account Maintain: (to close an account), and “Billing” (to allow the enterprise to bill the customer for financial services rendered). Each of these business functions also has attendant priority ratings. Note also that the business function “Account View” is performed by both actors that are directly associated with the enterprise (either as an employee or a customer) as well as “out of scope” actors (i.e., “Individual Consultants” and “Relationship Managers”) that may not be current users of a service associated with the business function of account view, but may be a user in the future.

Note that, in the example shown for a financial services enterprise, the functional domain “Advice” 204 includes the key processes of “Online Advice” (for advising customers in their selection of financial products) and “Suitability” (for determining if a customer is qualified to participate in a particular fund). Similarly, the functional domain “Investment Reporting” 206 includes the business functions of “Investment Performance” (for reporting on how a product is performing) and “Fund Comparisons and Enablers” (for comparing two or more funds). Note that different business functions and key processes are utilized by one or more actors, who may be in scope (currently using a service) or out of scope (not yet using a service).

Graphical representation 200 also shows utility functions 210 along the right vertical axis. These utility functions 210 may include, in the example of the financial services enterprise, “Alerts/Notifications” (providing alerts of anomalies that occur within a computer system (e.g., computer 100 shown in FIG. 1) of the enterprise), “Security” (protocol for limiting access to the enterprise's computer system), and “User Experience” (portals, user interfaces and other access presentations received and used by a customer). Note that the utility functions 210 may transcend across some or all of the functional domains (202-206). Note also that the utility functions 210 may also be assigned priority ratings that determine the order that existing enterprise utility functions are replaced with SOA-based utility functions.

As depicted in FIG. 2, graphical representation 200 presents a single view of an enterprise's business functions, and thus provides a useful business functional map for transitioning to SOA. This single view allows an evaluator to rapidly determine which functional domains, utility functions, business functions, and key processes are the best candidates for early conversion from an existing (or planned) non-SOA activity to a SOA activity.

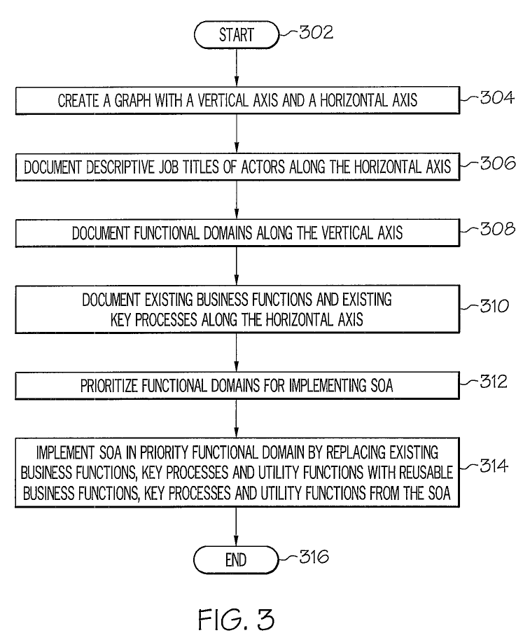

With reference now to FIG. 3, a high-level flow chart of steps taken to create a graphical representation, of an enterprise's activities, for use in conversion to an SOA environment is depicted. After initiator block 302, which may be prompted by an enterprise's decision to convert some or all functions and/or processes from existing non-SOA systems to SOA systems, a graph with a vertical and horizontal axis is created (block 304). Descriptive job titles of actors, both in scope and out of scope, are determined and documented along the horizontal axis of the graph (block 306). The determination of the descriptive job titles may be accomplished by a thorough manual or computer-driven evaluation of job descriptions of actors in the enterprise. Functional domains (e.g., 202-206 shown in FIG. 2) are then determined (by evaluating the primary categories of functions of the enterprise) and documented along on vertical axis of the graph (block 308). Each functional domain is a consolidation of business functions and key processes performed in the enterprise by the actors, where each business function is a group of logically connected tasks that are performed together to accomplish a business objective of the enterprise, and where each key process is a mission critical activity of a particular functional domain.

As described in block 310, existing business functions and existing key processes of the enterprise are determined and documented along the horizontal axis for each functional domain. Each of the functional domains is then prioritized for SOA implementation (block 312). Those functional domains with the highest priority settings are converted into SOA first (block 314), and the process ends at terminator block 316. In one embodiment, existing business functions and key processes within a highest priority functional domain are also prioritized for conversion to SOA. In one embodiment, all business functions and key processes within a particular functional domain are converted to SOA before another functional domain is converted to SOA. In another embodiment, prioritization of SOA conversion is functional domain independent, such that the highest priority business functions and/or key processes are converted to SOA, regardless of which functional domain they belong to.

As described herein, the process described (and particularly as associated with BTAMML 148) turns vertical thinking and communications into horizontal solutions. That is, rather than actors in an enterprise performing tasks without consideration of what other actors and/or departments are doing, the holistic approach for evaluating functions and processes of an enterprise described herein leads to a seamless transition into an SOA environment. Thus, instead of the enterprise evaluating what individual actors are doing, the enterprise evaluates what functional domains are doing. The presently described methodology and model allows enterprises to see where they conduct similar processes, thus identifying high level business processes that may require further decomposition.

Note that while the present invention has been described in the context of examining existing entities (i.e., functional domains, business functions, key processes, utility functions, etc.), the analytical steps described herein may also be utilized to evaluate planned, but not yet implemented, entities of the enterprise to determine if such planned entities are good candidates for conversion to SOA processes. Furthermore, in one embodiment the term “implementing” is understood to encompass the process of identifying likely methods and processes for conversion to SOA, as well as establishing a plan for such an SOA conversion.

Note also that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Note also that while the term “horizontal” and “vertical” are used in describing the model 200 shown in FIG. 2, these terms are used only to indicate a first and second direction in the model, and are not to be construed as limiting the scope of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for implementing a Service Oriented Architecture (SOA) in an enterprise through the use of a graphical representation of activities of the enterprise, the method comprising the steps of:
creating a graph with a vertical axis and a horizontal axis;
determining and documenting descriptive job titles of actors associated with the enterprise along the horizontal axis;
determining and documenting functional domains along the vertical axis, wherein each functional domain is a consolidation of business functions and key processes performed in the enterprise by the actors, wherein each business function is a group of logically connected tasks that are performed together to accomplish a business objective of the enterprise, and wherein each key process is a mission critical activity of a particular functional domain;
determining and documenting existing business functions and existing key processes of the enterprise along the horizontal axis for each functional domain;
prioritizing the functional domains to determine an order in which the SOA is implemented, wherein the SOA is first implemented in a particular prioritized functional domain; and
replacing, on a priority basis in the particular prioritized functional domain, the existing business functions of the enterprise with reusable business functions from the SOA.

2. The method of claim 1, further comprising:
priority replacing, in the particular prioritized functional domain, the existing key processes with reusable key processes from the SOA.

3. The method of claim 2, wherein prioritization of the functional domains, priority replacing of the existing business functions with reusable business functions, and priority replacing of the existing key processes with reusable key processes are based on a relative exposure of the functional domains, existing business functions, and existing key processes to a customer of the enterprise.

4. The method of claim 1, further comprising:
documenting one or more existing utility functions along the vertical axis; and
priority replacing the existing utility functions with reusable utility functions from the SOA, wherein priority replacing is based on an enterprise-defined hierarchy of the existing utility functions, and wherein the enterprise-defined hierarchy is based on a mission criticality of each of the existing utility functions.

5. The method of claim 4, wherein at least one of the utility functions are utilized by multiple functional domains.

6. The method of claim 5, wherein the utility functions include security functions for accessing an enterprise computer system, user interface functions for the enterprise computer system, and alert/notification functions for providing alerts of anomalies that occur within the enterprise computer system.

7. A system comprising:
a processor;
a data bus coupled to the processor;
a memory coupled to the data bus; and
a computer-usable medium embodying computer program code, the computer program code comprising instructions executable by the processor and configured for implementing a Service Oriented Architecture (SOA) in an enterprise through the use of a graphical representation of activities of the enterprise by performing the steps of:
creating a graph with a vertical axis and a horizontal axis;
determining and documenting descriptive job titles of actors associated with the enterprise along the horizontal axis;
determining and documenting functional domains along the vertical axis, wherein each functional domain is a consolidation of business functions and key processes performed in the enterprise by the actors, wherein each business function is a group of logically connected tasks that are performed together to accomplish a business objective of the enterprise, and wherein each key process is a mission critical activity of a particular functional domain;
determining and documenting existing business functions and existing key processes of the enterprise along the horizontal axis for each functional domain;
prioritizing the functional domains to determine an order in which the SOA is implemented, wherein the SOA is first implemented in a particular prioritized functional domain; and
replacing, on a priority basis in the particular prioritized functional domain, the existing business functions of the enterprise with reusable business functions from the SOA.

8. The system of claim 7, wherein the instructions are further configured for:
priority replacing, in the particular prioritized functional domain, the existing key processes with reusable key processes from the SOA.

9. The system of claim 8, wherein prioritization of the functional domains, priority replacing of the existing business functions with reusable business functions, and priority replacing of the existing key processes with reusable key processes are based on a relative exposure of the functional domains, existing business functions, and existing key processes to a customer of the enterprise.

10. The system of claim 7, wherein the instructions are further configured for:
documenting one or more existing utility functions along the vertical axis; and
priority replacing the existing utility functions with reusable utility functions from the SOA, wherein priority replacing is based on an enterprise-defined hierarchy of the existing utility functions, and wherein the enterprise-defined hierarchy is based on a mission criticality of each of the existing utility functions.

11. The system of claim 10, wherein at least one of the utility functions are utilized by multiple functional domains.

12. The system of claim 11, wherein the utility functions include security functions for accessing an enterprise computer system, user interface functions for the enterprise computer system, and alert/notification functions for providing alerts of anomalies that occur within the enterprise computer system.

13. A computer-readable medium encoded with a computer program, the computer program comprising computer executable instructions configured for:
creating a graph with a vertical axis and a horizontal axis;
determining and documenting descriptive job titles of actors associated with the enterprise along the horizontal axis;
determining and documenting functional domains along the vertical axis, wherein each functional domain is a consolidation of business functions and key processes performed in the enterprise by the actors, wherein each business function is a group of logically connected tasks that are performed together to accomplish a business objective of the enterprise, and wherein each key process is a mission critical activity of a particular functional domain;
determining and documenting existing business functions and existing key processes of the enterprise along the horizontal axis for each functional domain;
prioritizing the functional domains to determine an order in which the SOA is implemented, wherein the SOA is first implemented in a particular prioritized functional domain; and
replacing, on a priority basis in the particular prioritized functional domain, the existing business functions of the enterprise with reusable business functions from the SOA.

14. The computer-readable medium of claim 13, wherein the computer executable instructions are further configured for:
priority replacing, in the particular prioritized functional domain, the existing key processes with reusable key processes from the SOA.

15. The computer-readable medium of claim 14, wherein prioritization of the functional domains, priority replacing of the existing business functions with reusable business functions, and priority replacing of the existing key processes with reusable key processes are based on a relative exposure of the functional domains, existing business functions, and existing key processes to a customer of the enterprise.

16. The computer-readable medium of claim 13, wherein the computer executable instructions are further configured for:
documenting one or more existing utility functions along the vertical axis; and
priority replacing the existing utility functions with reusable utility functions from the SOA, wherein priority replacing is based on an enterprise-defined hierarchy of the existing utility functions, and wherein the enterprise-defined hierarchy is based on a mission criticality of each of the existing utility functions.

17. The computer-readable medium of claim 16, wherein at least one of the utility functions are utilized by multiple functional domains.

18. The computer-readable medium of claim 17, wherein the utility functions include security functions for accessing an enterprise computer system, user interface functions for the enterprise computer system, and alert/notification functions for providing alerts of anomalies that occur within the enterprise computer system.

19. The computer-readable medium of claim 13, wherein the computer-usable medium is a component of a remote server, and wherein the computer executable instructions are deployable to a local client computer from the remote server.

20. The computer-readable medium of claim 13, wherein the computer executable instructions are capable of being provided by a service provider to a customer on an on-demand basis.
